(19) United States
(12) Patent Application Publication
(10) Pub. No.: US 2010/0101147 A1
(43) Pub. Date: Apr. 29, 2010

(54) AUTOMATIC HINGE FOR DOORS, SHUTTERS, GATES ETC.

(76) Inventor: Tony Vankrunkelsven, Leopoldsburg (BE)

Correspondence Address: BACON & THOMAS, PLLC, 625 SLATERS LANE, FOURTH FLOOR, ALEXANDRIA, VA, 22314-1176, US

(21) Appl. No.: 12/532,300

(22) PCT Filed: Mar. 19, 2008
(86) PCT No.: PCT/EP2008/053306

§ 371 Date: Oct. 13, 2009

(30) Foreign Application Priority Data
Mar. 22, 2007 (BE) 2007/0138

(51) Int. Cl. E05F 15/12

(52) U.S. Cl. 49/334

(57) ABSTRACT

The invention concerns a motorized automatic hinge device with a rotatable support device for mounting of a door, shutter, gate or similar, at least one drive motor with transmissions for achieving the rotation of said rotatable support device, and power supply and control elements for said drive motor(s) and transmissions, wherein the support device for the door, shutter or gate is arranged in a hollow, substantially cylindrical outer structure in which said support device is accommodated, and wherein the motor(s) and transmissions are arranged within said substantially cylindrical outer structure such that, on activation of the control device, they cause said substantially cylindrical outer structure to rotate about its axis.

The invention concerns a motorised automatic hinge device for the door, shutter and gate industry, more specifically the door, shutter and gate installation industry.

The new hinge according to the invention replaces, in the current system, the post, the hinge and the automation unit, and has the advantage that the installer need merely attach the door, shutter or gate. As a result, an extremely safe situation is achieved as there is no possibility of becoming trapped between hinge, post, door/shutter/gate and automation unit.

The motorised automatic hinge device for doors, shutters or gates according to the invention comprises a rotatable support unit for mounting the door, shutter or gate, at least one drive motor with transmission for rotating said rotatable support unit, a power supply and control elements for said drive motor(s) and transmissions, wherein more specifically the device comprises a hollow, substantially cylindrical outer structure on which said support unit for a door, shutter or gate is attached, and wherein said motor and transmissions are arranged within said substantially cylindrical outer structure such that these, on activation of said control element, cause said substantially cylindrical outer structure to rotate about its axis.

The principle is therefore that the rotation mechanism and the control mechanism and the drive mechanism are provided internally inside the supporting structure (hollow cylinder) for the gate, door etc.

The invention concerns both a hinge device according to this principle and also the application of said principle for the operation of swing gates and swing doors.

The drive motor(s) are preferably tubular motors.

More specifically, the motor (with transmission) is of the roller shutter motor type.

A reduction device can be very suitably used here to reduce the rotation speed of the roller shutter motor to between 0.5 and 7.5 revolutions per minute, preferably between 4 and 1.3 revolutions per minute.

The principle of the invention is explained in more detail with reference to the attached drawings on which:

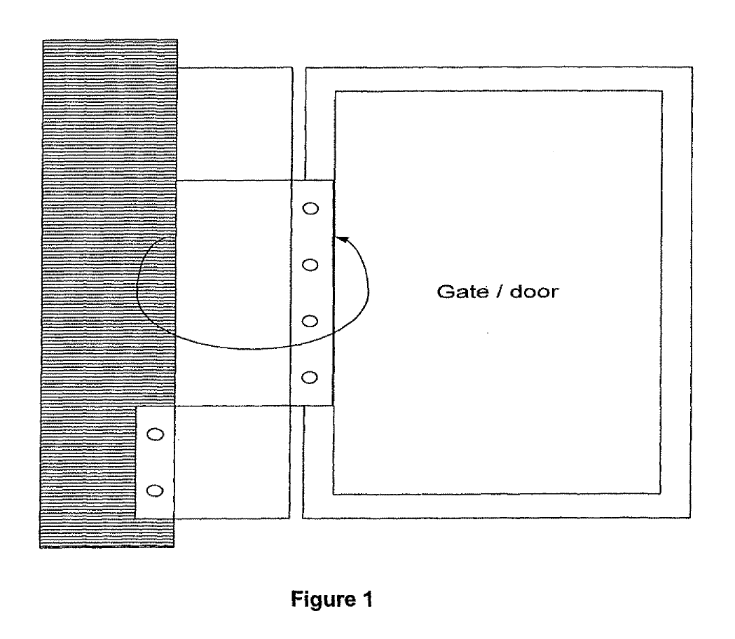

FIG. 1 is a principle view of the attachment to a wall

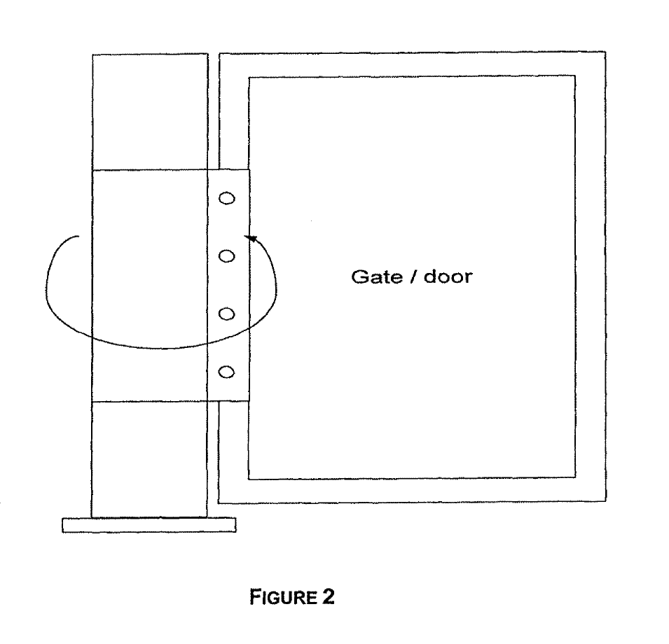

FIG. 2 is a principle view of the attachment to a foundation

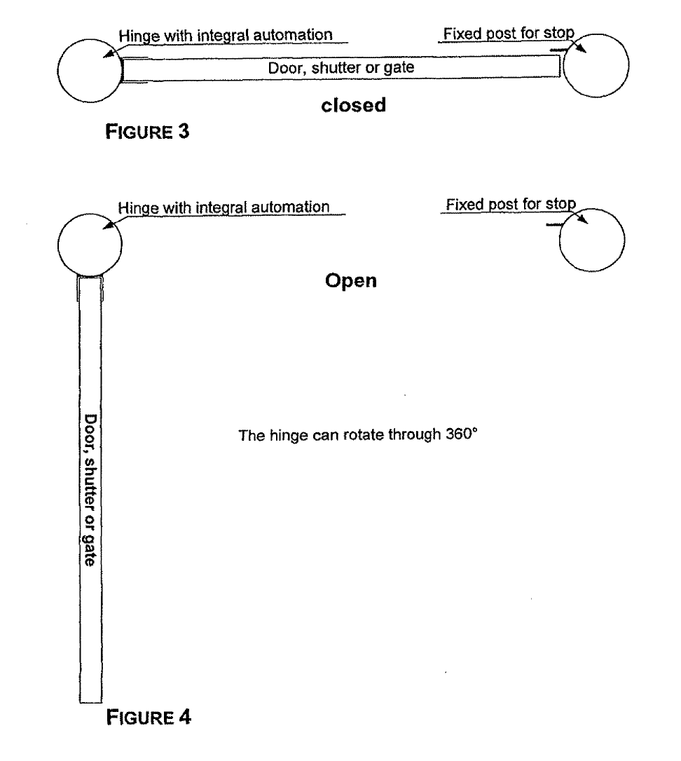

FIGS. 3 and 4 show a top view of the system according to the invention, in closed and open situation respectively

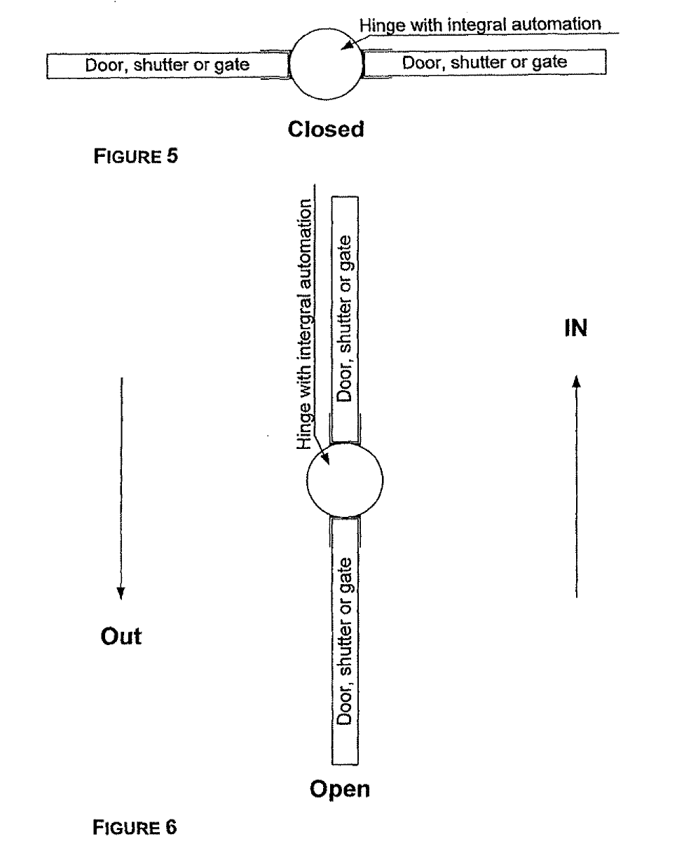

FIGS. 5 and 6 show the system according to the invention as a central hinge for entrance and exit in closed and open situation respectively

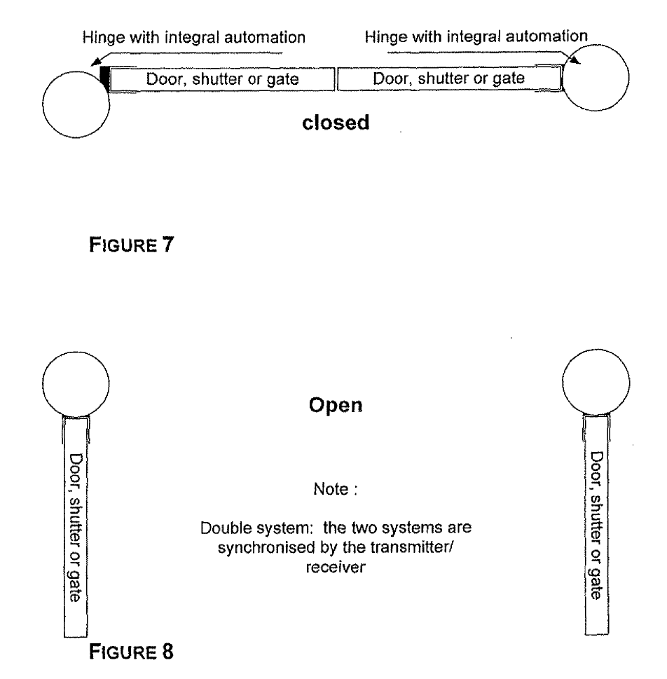

FIGS. 7 and 8 show the system according to the invention as a double hinge, synchronised, in closed and open situation respectively

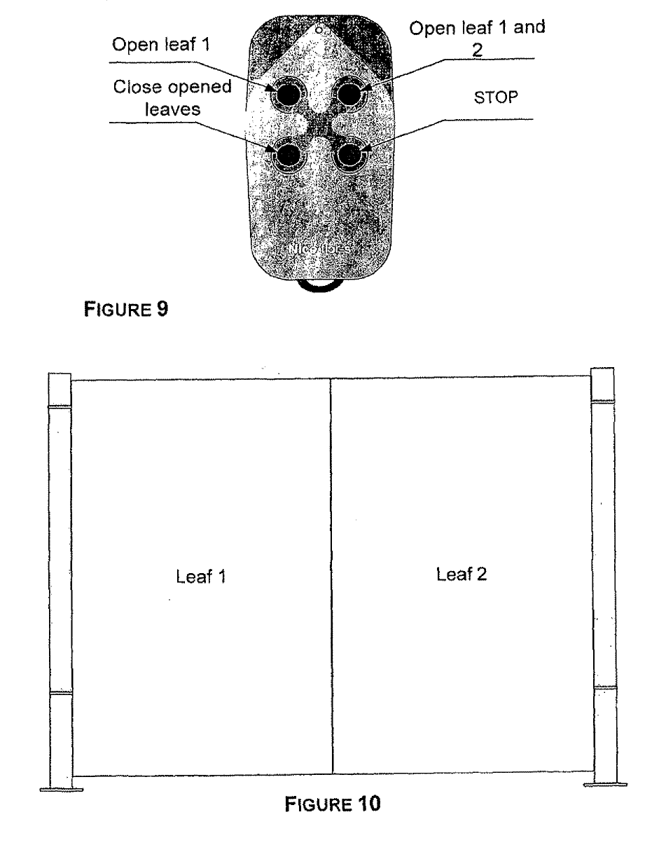

FIG. 9 illustrates the principle of a transmitter (remote control) for the gate with two open-swinging leaves

FIG. 10 shows the synchronisation of two leaves of a gate/door

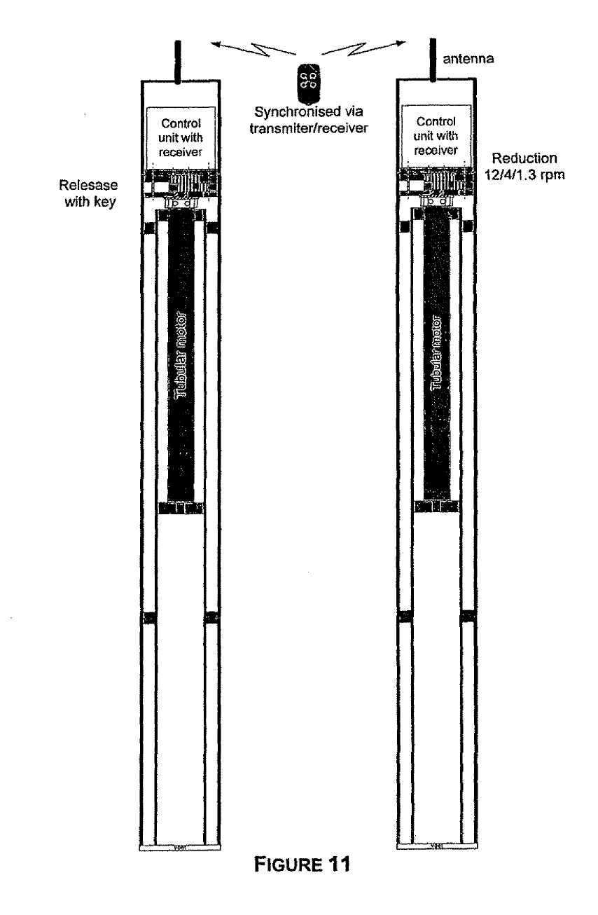

FIG. 11 illustrates further the principle of function of the installation with a transmitter/receiver

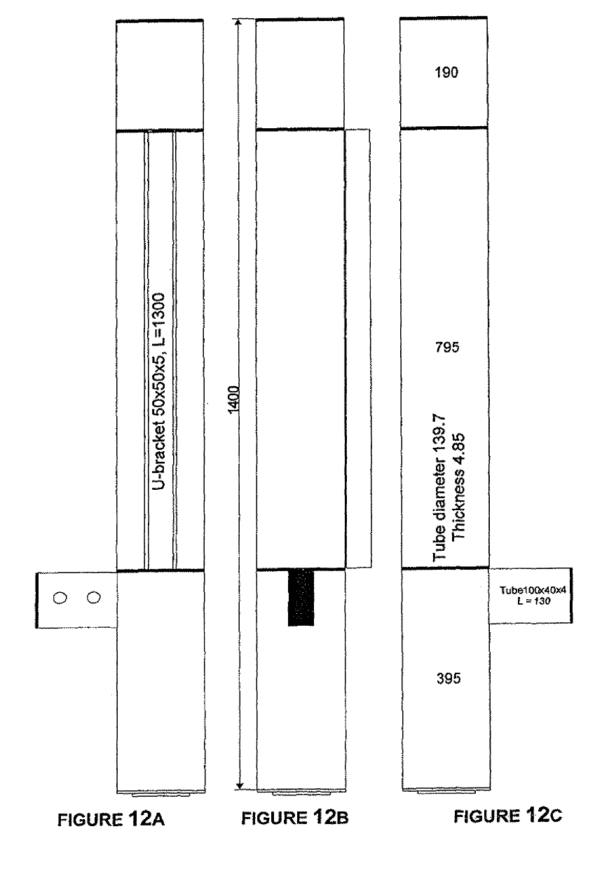

FIG. 12 illustrates a number of possible embodiment aspects/dimensions of the system according to the invention, in front, side and rear view

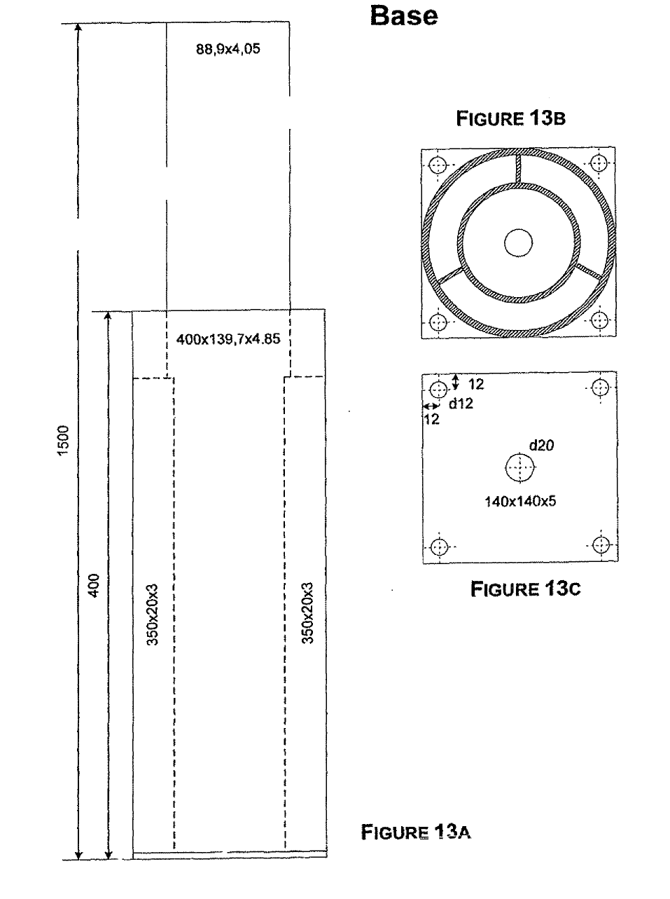

FIG. 13 illustrates further possible embodiment aspects/dimensions for attachment of the system according to the invention on a base (wall fixing in front view, and fixing on a foundation in top and bottom view respectively).

The system according to the invention can be placed perfectly as “stand-alone” on a foundation.

By pre-assembling the hinges and synchronisation with the transmitter/receiver, only the electrical installation 220V need be attached to each hinge even if extra security of photocells is used. Depending on whether we fit one, two or more hinges, we can program these in advance. This means that the installer receives in advance a system ready for installation.

We know from experience that on installation of automatic systems, very often problems arise in that in very many cases, the supplier must carry out very costly interventions in order to complete the assembly properly as far as possible. Not to mention the poor publicity for the installer, supplier and product.

One essential aspect of the new device according to the invention is also its extreme safety in comparison with existing systems with motors on the inside of the door and bar fixings between the mounting post and the motor, or systems with elbow arms which comprise a very dangerous and very powerful “scissor” system.

We are convinced that the very high safety and very simple installation constitute major progress in this sector.

With a system according to the invention, up to 64 transmitters can be programmed following the example in FIG. 9, which at the same time also ensure synchronisation of the two leaves as illustrated in FIG. 10.

Translation of the References of the Drawings

FIG. 1

Gate/door

FIG. 2

Gate/door

FIG. 3

Hinge with integral automation Fixed post for stop

Door, shutter or gate

Closed

FIG. 4

Hinge with integral automation Fixed post for stop

Door, shutter or gate

Open

The hinge can rotate through 360°

FIG. 5

Hinge with integral automation

Door, shutter or gate

Closed

FIG. 6

Hinge with integral automation

Door, shutter or gate

Open

Out

In

FIG. 7

Hinge with integral automation

Door, shutter or gate

Closed

FIG. 8

Open

Door, shutter or gate

Note:

Double system: the two systems are synchronised by the transmitter/receiver.

FIG. 9

Open leaf 1 Open leaf 1 and 2

Close opened leaves Stop

FIG. 10

Leaf 1 Leaf 2

FIG. 11

Synchronised via transmitter/receiver Antenna

Control unit with receiver Control unit with receiver

Release with key Reduction 12/4/1.3 rpm

Tubular motor Tubular motor

FIG. 12A U-bracket 50×50×5, L=1300

FIG. 12C

Tube diameter 139.7, thickness 4.85

Tube 100×40×4, L=130

FIG. 13

Base

1-4. (canceled)

5. Motorised automatic hinge device for doors, shutters, gates and similar, comprising a rotatable support device for mounting of a door, shutter or gate, at least one drive motor with transmissions for causing the rotation of said rotatable support device, and power supply and control elements for said drive motor(s) and transmissions, wherein the hinge device has a hollow, substantially cylindrical outer structure in which said support device for a door, shutter or gate is accommodated, and said motor(s) and transmissions are arranged in said substantially cylindrical outer structure such that said motor(s) and transmissions, on activation of said control device, cause said substantially cylindrical outer structure to rotate about its axis.

6. Hinge device according to claim 5, wherein the motor is a tubular motor. 7, (New) Hinge device according to claim 5, wherein said motor with transmissions comprises a roller shutter type motor.

8. Hinge device according to claim 7, including a reduction device arranged to reduce the rotation speed of the roller shutter motor to between 0.5 and 7.5 revolutions per minute.
